(19) United States
(12) Patent Application Publication
(10) Pub. No.: US 2010/0300829 A1
(43) Pub. Date: Dec. 2, 2010

(54) BILL BOX WITH WIRELESS MEMORY FUNCTION FOR BILL ACCEPOR

(75) Inventors: WEI-JR CHEN, TAIPEI (TW); CHENG-KANG YU, TAIPEI (TW); YUEH-PING HSU, TAIPEI (TW)

Correspondence Address: INTERNATIONAL CURRENCY TECHNOLOGIES CORPORATION, P.O. BOX 108-00403, TAIPEI, 106, omitted

(73) Assignee: INTERNATIONAL CURRENCY TECHNOLOGIES CORPORATION, TAIPEI (unknown)

(21) Appl. No.: 12/475,618

(22) Filed: Jun. 1, 2009

(51) Int. Cl. G07F 7/04; G06K 7/00

(52) U.S. Cl. 194/206; 340/10.1

(57) ABSTRACT

A bill box for use in a bill acceptor having a RFID read/write module and adapted for receiving bills from the bill acceptor is disclosed to include a housing having a bill inlet, a bill storage chamber and a top bracket with a mounting chamber, and a memory carrier frame mounted in the mounting chamber of the bracket and carrying a RFID memory for recording bill storage data by the wireless read/write module of the bill acceptor wirelessly for quick bill storage check.

### BACKGROUND OF THE INVENTION

1. Field of the Invention

The present invention relates to bill boxes for bill acceptor and more particularly, to a bill box with wireless memory function, which carries a RFID memory for recording the data of bill storage amount and value by the bill acceptor wirelessly.

2. Description of the Related Art

Following fast development of technology, the distance among people has been greatly shortened, our mode of living has been changed, and different automatic vending machines are used everywhere to sell different products without serviceman. These automatic vending machines are highly invited for the advantage of saving much labor and bringing convenience to people. For example, a Q-shop has the advantages of scientific intelligence, quick service, and quick finish of payment. A Q-shop may provide automatic vending machines for vending drinks, cigarettes, tickets, ice creams, tickets, memorial coins, key rings, or even hamburgers and noodles. Nowadays, many virtual shops are established to make online shopping, allowing shoppers to shop across millions of products.

An automatic vending machine generally comprises a bill/coin acceptor to recognize the authenticity and value of each inserted bill/coin, and a bill/coin box for storing each received bill/coin. Workers regularly visit installed automatic vending machines to take back the installed bill/coin box from each installed automatic vending machine and to install an empty bill/coin box in each installed automatic vending machine as a replacement. The collected bill/coin boxes are carried back to the company for checking the storage bills/coins. After removal of a bill/coin box from an automatic vending machine, any person of the company does not know the actual total amount of the bills/coins in the bill/coin box, i.e., the company does not know the actual total transaction amount of every automatic vending machine before opening the bill/coin box. This management process cannot prevent workers from stealing money from bill/coin boxes.

### SUMMARY OF THE INVENTION

The present invention has been accomplished under the circumstances in view. It is one object of the present invention to provide a bill box with wireless memory function, which carries a RFID memory for recording the data of bill storage amount and value by the bill acceptor wirelessly.

To achieve this and other objects of the present invention, a bill box comprises a bill acceptor having a RFID read/write module and adapted for receiving bills from the bill acceptor is disclosed to include a housing having a bill inlet, a bill storage chamber and a top bracket with a mounting chamber, and a memory carrier frame mounted in the mounting chamber of the bracket and carrying a RFID memory for recording bill storage data by the wireless read/write module of the bill acceptor wirelessly for speeding bill storage check.

Further, the housing of the bill box comprises an access hole, an access door hinged to one side of the access hole, and a door lock for locking the access door in the close position. The top bracket has a finger slot. The memory carrier frame has a finger strip suspending in the finger slot. When unlocked the door lock to open the access door, a worker can insert the fingers into the finger slot to pull the finger strip and to further remove the memory carrier frame from the top bracket for a maintenance work.

### BRIEF DESCRIPTION OF THE DRAWINGS

FIG. 1 is an oblique elevation of a bill box in accordance with the present invention.

FIG. 2 is an exploded view of the bill box in accordance with the present invention.

FIG. 3 is an enlarged view of a part of FIG. 2.

FIG. 4 corresponds to FIG. 3 when viewed from another angle.

FIG. 5 is a sectional view of the present invention, showing the bill box installed in a bill acceptor.

FIG. 6 is a block diagram showing the relationship of the bill box relative to a bill acceptor and a display device.

### DETAILED DESCRIPTION OF THE PREFERRED EMBODIMENT

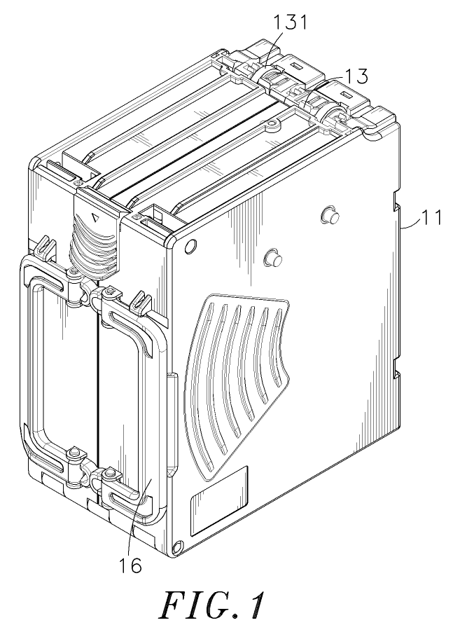

Referring to FIGS. 1˜4, a bill box for use in a bill acceptor in accordance with the present invention is shown comprising a housing 1 and a memory carrier frame 2.

The housing 1 comprises a plurality of cover shells 11, a bill inlet 13 defined in a rear side, a bill storage chamber 12 defined therein in communication with the bill inlet 13 for receiving bills been delivered into the bill inlet 13, a bill transferring mechanism 131 arranged at two opposite lateral sides of the bill inlet 13 and adapted to transfer bills from a bill acceptor (not shown) through the bill inlet 13 into the bill storage chamber 12, a bill bearing plate 121 suspending in the bill storage chamber 12 for holding bills in the bill storage chamber 12, a plurality of spring members 122 mounted inside the bill storage chamber 12 and adapted to impart a pressure to the bill bearing plate 121 toward the bill inlet 13, a bill press mechanism 132, which comprises a plurality of links 1321 and a bill press board 1322 movable by the links 1321 to push bills away from the bill inlet 13 to the bill bearing plate 121, a bracket 14 located on the top side, an access hole 15 defined in the bottom side opposite to the bracket 14, an access door 151 hinged to one side of the access hole 15 and adapted to close the access hole 15, a door lock 152 mounted in the access door 15 for locking the access door 15 in the close position, and a handle 16 located on one cover shell 11 at the front side of the housing 1 opposite to the bill inlet 13. The bracket 14 has a mounting chamber 141, a plurality of locating grooves 142 disposed at two opposite lateral sides relative to the mounting chamber 141, a finger slot 143 formed in one locating groove 142, and a plurality of stop grooves 144 formed in front and rear sides in the mounting chamber 141.

The memory carrier frame 2 is mounted in the mounting chamber 141 of the bracket 14 and carrying a RFID memory 21, having a plurality first locating lugs 22 located on one lateral side for engaging into the locating grooves 142 at one lateral side in the mounting chamber 141, a springy flange 23 upwardly extended from the other lateral side, two second locating lugs 231 bilaterally protruded from the springy flange 23 for engaging the locating grooves 142 at the other lateral side in the mounting chamber 141, a finger strip 232 protruded from the springy flange 23 between the second locating lugs 231 corresponding to the finger slot 143 of the bracket 14, and a plurality of stop strips 24 respectively located on the front and rear sides for stopping at the stop grooves 144.

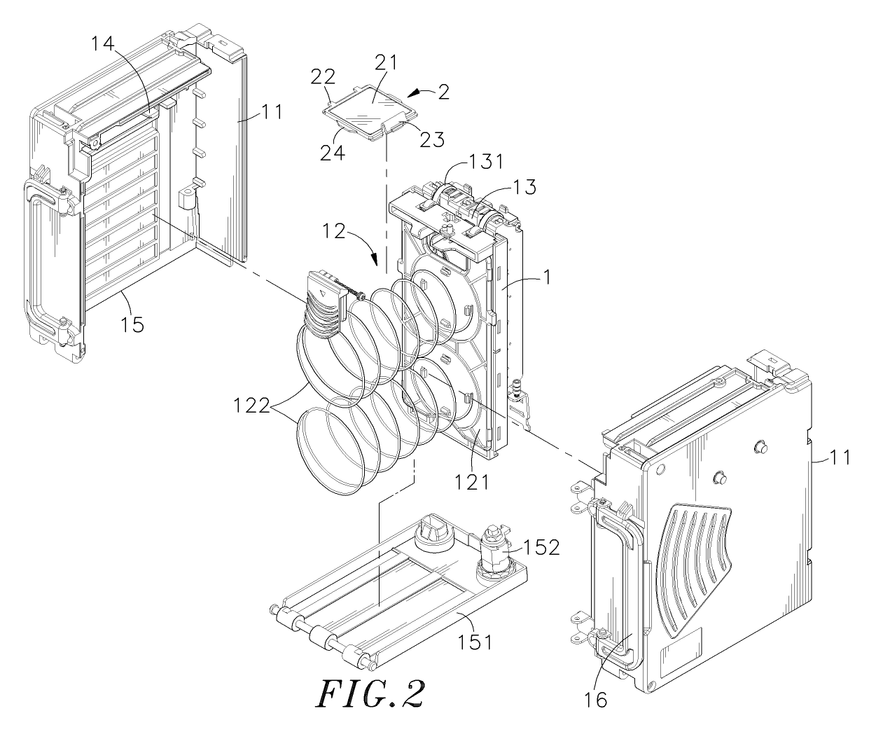

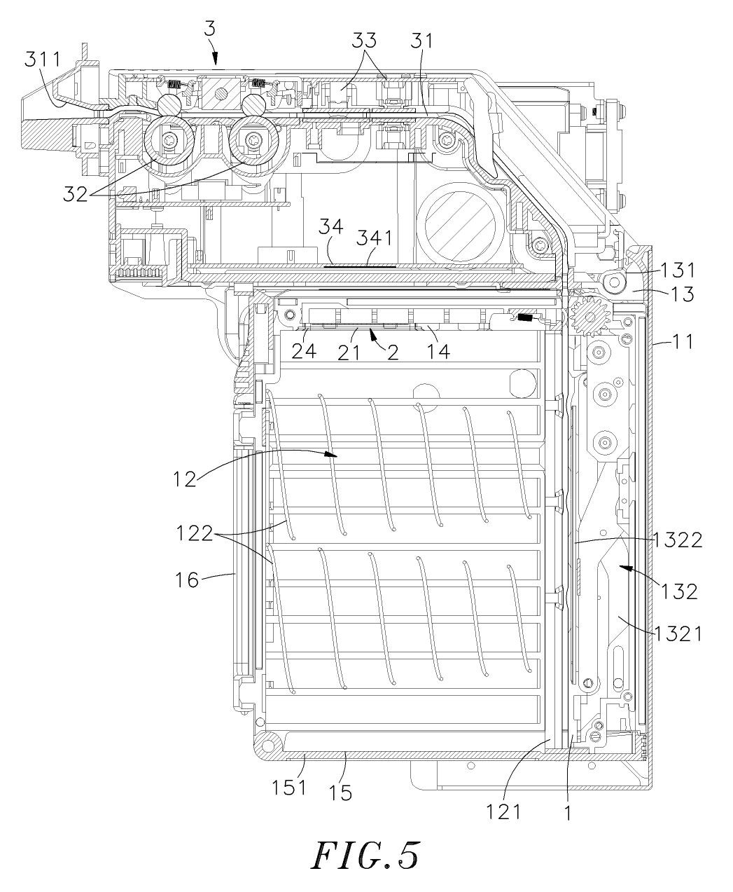

Referring to FIG. 5 and FIGS. 2˜4 again, the bill box is installed in one side of a bill acceptor 3. The bill acceptor 3 comprises a bill insertion slot 311 located on the front side, a bill passage 31 backwardly extended from the bill insertion slot 311 and kept in communication with the bill inlet 13 of the bill box, a bill delivery mechanism 32 arranged on top and bottom sides of the bill passage 31 for delivering each inserted bill from the bill insertion slot 311 through the bill passage 31 into the bill inlet 13 of the bill box, a recognition module 33 installed in one side of the bill passage 31 for checking the authenticity and face value of each inserted bill, and a circuit board 34 disposed adjacent to the housing 1 of the bill box. The circuit board 34 comprises a RFID read/write module 341.

When a bill is inserted through the bill insertion slot 311 of the bill acceptor 3 into the bill passage 31, the bill delivery mechanism 32 carries the inserted bill forwards to a predetermined position for recognition by the recognition module 33. If the inserted bill is checked to be a counterfeit bill, the bill delivery mechanism 32 reverses the counterfeit bill to the bill insertion slot 311. When the inserted bill is recognized to be a true bill, the bill delivery mechanism 32 immediately delivers the bill to the bill inlet 13 of the bill box at rear end of the bill passage 31, enabling the bill to be carried forwards by the bill transferring mechanism 131 into the inside of the bill inlet 13. At this time, the links 1321 of the bill press mechanism 132 are driven to move the bill press board 1322, causing the bill press board 1332 to push the bill away from the bill inlet 13 to the bill bearing plate 121 in the bill storage chamber 12 against the spring members 122. Thus, the bill is stored in the bill storage chamber 12.

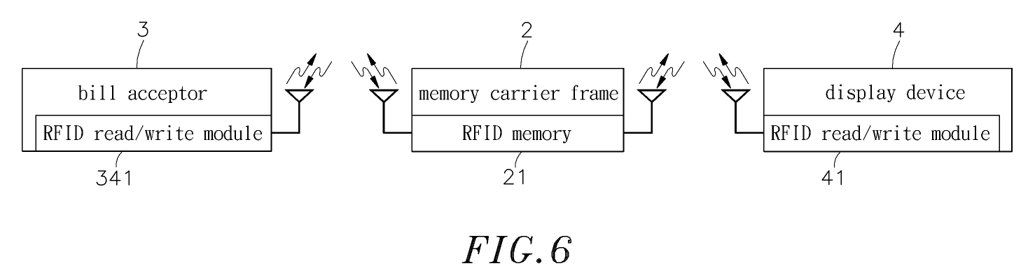

Referring to FIG. 6 and FIG. 5 again, after recognition of the authenticity and face value of a bill by the recognition module 33, the recognition module 33 immediately transmits the related data to the RFID read/write module 341. Upon receipt of the data from the recognition module 33, the RFID read/write module 341 transmits the data to the RFID memory 21 and stores the data in the RFID memory 21 wirelessly. When an authorized person detached the bill box from the bill acceptor 3, the authorized person can carry the handle 16 of the bill box to move the bill box to a display device 4 having a RFID read/write module 41 and then to attach one side of the bill box to the display device 4 for enabling the RFID read/write module 41 to read the storage data from the RFID memory 21 of the bill box and to display the data on a display screen of the display device 4.

The RFID read/write module 341 of the bill acceptor 3 and the RFID read/write module 41 of the display device 4 commonly consist of an antenna and a transceiver and are capable of reading and/or writing to a RFID memory. Because RFID technology is of the known art, no further detailed description in this regards is necessary.

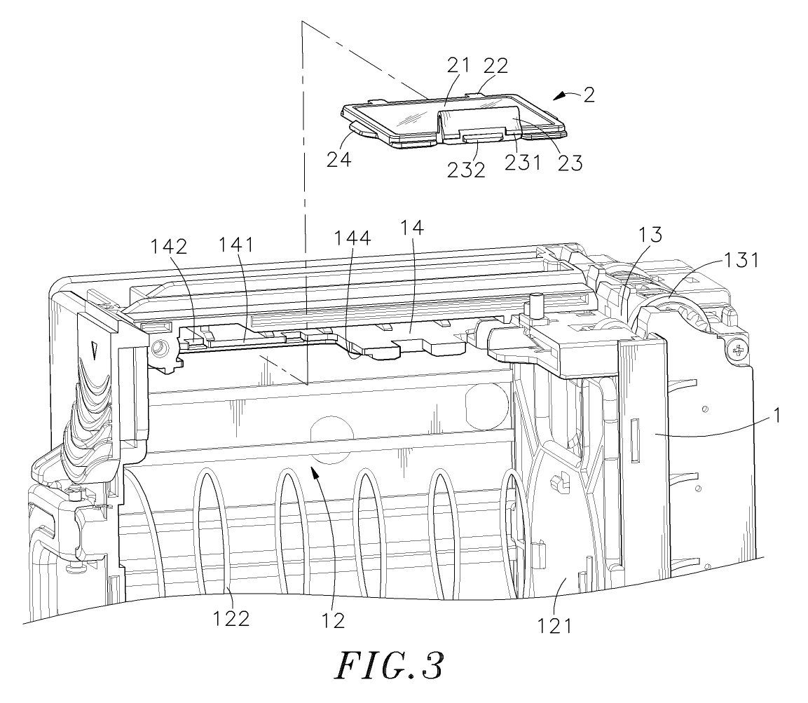

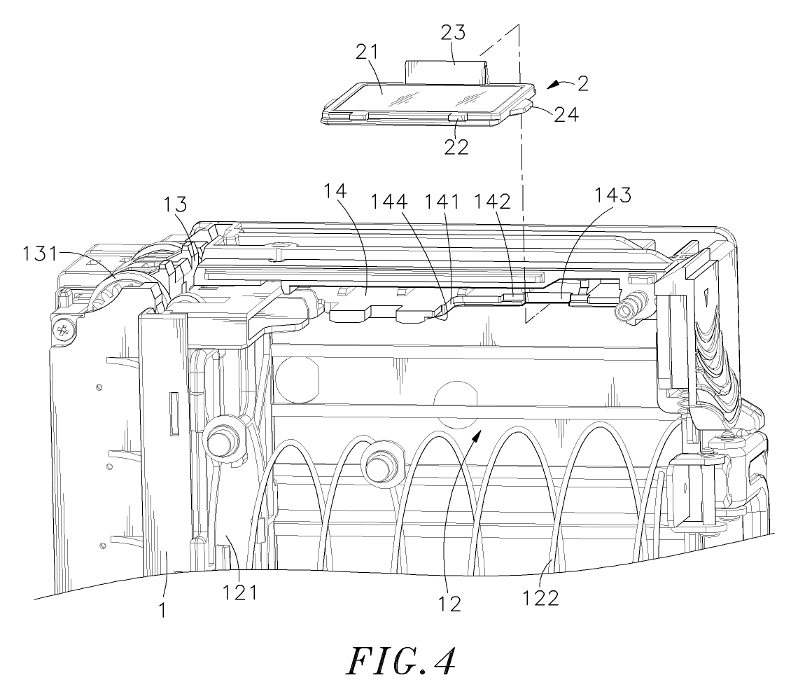

Referring to FIGS. 2-5 again, the bill box that is installed in the bill acceptor 3 is regularly replaced with an empty bill box manually by a company staff or security person. By means of attaching the bill box that is detached from the bill acceptor 3 to the display device 4 for enabling the RFID read/write module 41 to read the storage data from the RFID memory 21 of the bill box and to display the data on the display screen of the display device 4, the company staff or security person can unlock the door lock 152 and open the access door 151, and then take the stacked bills out of the access hole 15 of the bill box, and then check the total value of the bills with the data displayed on the display screen of the display device 4 to see any incorrectness.

Further, the RFID memory 21 of the memory carrier frame 2 is mounted in the mounting chamber 141 of the bracket 14 with its first locating lugs 22 and second locating lugs 231 respectively engaged into the locating grooves 142 of the bracket 14 and its finger strip 232 set in the finger slot 143 of the bracket 14. If the RFID memory 21 fails, a maintenance engineer can insert the hand into the finger slot 143 to elastically temporarily deform the springy flange 23 and to disengage the second locating lugs 231 from the associating locating grooves 142 of the bracket 14, allowing removal of the memory carrier frame 2 from the mounting chamber 141 of the bracket 14 for a repair work. Further, before removing the memory carrier frame 2 from the mounting chamber 141 of the bracket 14, the maintenance engineer must unlock the door lock 152 with a key and then open the access door 151. Because the key is held in the hand of an authorized person and because the RFID memory 21 has recorded therein the total value of the bills stacked in the bill box, the invention effectively prevents any non-authorized person from stealing bills from the bill box or to replace the RFID memory 21.

In conclusion, the invention provides a bill box with memory function that has the following features and advantages:

1. The housing 1 of the bill box has a memory carrier frame 2 with a RFID memory 21 mounted therein. After installation of the bill box in a bill acceptor 3 having a circuit board 34 with a RFID read/write module 341, the RFID memory 21 is kept adjacent to the RFID read/write module 341. Each time the bill acceptor 3 recognized and received a genuine bill, the RFID read/write module 341 writes the related data into the RFID memory 21 wirelessly. Therefore, the RFID memory 21 of the bill box records the face value of each received bill for easy checking.

2. After removal of the bill box from the bill acceptor, the bill box can be attached with the side on which the RFID memory 21 is located to a display device 4 having a RFID read/write module 41, enabling the RFID read/write module 41 to read in storage data from the RFID memory 21 wirelessly for display on the display screen of the display device 4.

3. If the RFID memory 21 fails, a maintenance engineer can get the key from the authorized person and open the access door 151 and then remove the memory carrier frame 2 from the mounting chamber 141 of the bracket 14 for a repair work.

A prototype of bill box with wireless memory function for bill acceptor has been constructed with the features of FIGS. 1˜6. The bill box with wireless memory function for bill acceptor functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill box used in a bill acceptor having a wireless read/write module and adapted for receiving bills from said bill acceptor, comprising:
a housing formed of a plurality of cover shells, said housing comprising a bill inlet for receiving bills from said bill acceptor, a bill storage chamber defined therein in communication with said bill inlet for storage of bills, and a bracket located on one side relative to said bill storage chamber, said bracket defining a mounting chamber; and
a memory carrier frame mounted in said mounting chamber of said bracket and carrying a wireless memory for recording bill storage data by said wireless read/write module of said bill acceptor wirelessly.

2. The bill box as claimed in claim 1, wherein said housing further comprises a bill bearing plate suspending in said bill storage chamber for holding bills in said bill storage chamber, a plurality of spring members mounted inside said bill storage chamber and adapted to impart a pressure to said bill bearing plate toward said bill inlet, and a bill press mechanism adapted to push each bill being delivered into said bill inlet away from said bill inlet to said bill bearing plate.

3. The bill box as claimed in claim 2, wherein said bill press mechanism comprises a plurality of links, and a bill press board movable by said links to push each bill being delivered into said bill inlet away from said bill inlet to said bill bearing plate.

4. The bill box as claimed in claim 1, wherein said housing further comprises a bill transferring mechanism arranged at two opposite lateral sides relative to said bill inlet and adapted to transfer bills from said bill acceptor through said bill inlet into said bill storage chamber.

5. The bill box as claimed in claim 1, wherein said bracket of said housing further comprises a plurality of locating grooves located on two opposite sides of said mounting chamber; said memory carrier frame comprises a plurality of first mounting lugs and a springy flange disposed at two opposite sides for engaging said locating grooves to secure said memory carrier frame to said mounting chamber.

6. The bill box as claimed in claim 5, wherein said memory carrier frame further comprises a plurality of second mounting lugs protruded from said springy flange for engaging said locating grooves.

7. The bill box as claimed in claim 5, wherein said bracket further comprises a plurality of stop grooves disposed at two opposite sides relative to said locating grooves; said memory carrier frame further comprises a plurality of stop strips for stopping at said stop grooves.

8. The bill box as claimed in claim 7, wherein said bracket further comprises a finger slot; said memory carrier frame further comprises a finger strip suspending in said finger slot for pulling by a person to elastically deform said springy flange and to disengage said springy flange from said locating grooves.

9. The bill box as claimed in claim 1, wherein said housing further comprises an access hole, and an access door adapted to close said access hole.

10. The bill box as claimed in claim 9, wherein said access door comprises a first lateral side hinged on one lateral side of said access hole, a second lateral side opposing said first lateral side, and a door lock mounted in said second lateral side for locking said second lateral side to an opposite lateral side of said access hole.

11. The bill box as claimed in claim 1, wherein said wireless memory is a RFID memory.

12. The bill box as claimed in claim 1, wherein said housing further comprises a handle disposed at one side thereof opposite to said bill inlet.
